(19) United States
(12) Patent Application Publication
(10) Pub. No.: US 2011/0214344 A1
(43) Pub. Date: Sep. 8, 2011

(54) Greenhouse and Method of Making Same

(76) Inventor: Paul D. Kahn, Oshawa (CA)

(21) Appl. No.: 13/042,131

(22) Filed: Mar. 7, 2011

(30) Foreign Application Priority Data
Mar. 8, 2010 (CA) 2695736

(51) Int. Cl. A01G 9/14; B31B 17/00

(52) U.S. Cl. 47/17; 493/84

(57) ABSTRACT

A greenhouse comprising at least one elongate self supporting tube having a wall defining an interior space. The at least one elongate tube is formed from a light transmissive material to permit plant growth within said interior space. The at least one tube is supported by a base support system. A plurality of tubes may be arranged into an assembly shaped like a pyramid. Growing medium and/or at least one solar panel may be disposed in the interior space of the topmost tube. One or a plurality of assemblies may be attached to a building to form a facility. A plurality of facilities may be arranged in proximity to one another.

### FIELD OF THE INVENTION

This invention relates to the field of agriculture. More particularly, the present invention relates to structures and methods of making structures for growing plants in a climate controlled environment protected from adverse weather conditions, insects, and animals. More particularly still, the present invention relates to greenhouses and methods of making greenhouses.

### BACKGROUND OF THE INVENTION

Generally speaking, plants grow when planted in soil having specific attributes, and provided with specific amounts of sunlight, water, and ambient temperature, as well as being protected from adverse weather conditions, insects and animals. The optimum growing environment for any given plant typically varies from that of another plant. Moreover, plants will not grow well, if at all, in certain regions where the environment is sub-optimal.

Accordingly, there have been many approaches attempts to provide for a controlled plant growing environment wherein temperature, moisture, and/or light, among numerous other parameters, are controlled. Some examples of plant protective devices, enclosures, covers, and greenhouses include U.S. Pat. No. 707,247 (Merriman), U.S. Pat. No. 2,816,329 (Sogaro), U.S. Pat. No. 3,800,468 (Graft), U.S. Pat. No. 4,160,340 (Levett), U.S. Pat. No. 4,347,685 (Medford), U.S. Pat. No. 4,597,220 (Bourrie), U.S. Pat. No. 4,612,726 (Mori), U.S. Pat. No. 4,679,350 (Banta), U.S. Pat. No. 4,768,307 (Holowecky), U.S. Pat. No. 6,536,157 (Wijbenga), U.S. Pat. No. 6,578,316 (Temple), and U.S. Patent Application Publication No. 2004/0049976 (Maffei).

A feature of all of the above protective devices, enclosures, covers, and greenhouses is that their plant growing area is limited to the bounds of the area which they enclose or cover. Moreover, since the prior protective devices, enclosures, covers, and greenhouses are intended for use on a particular piece of land, the maximum plant growing area will never be more than the area of the piece of land.

Furthermore, a problem with some of the protective devices, enclosures, covers, and greenhouses is that they are designed to either rest on top of the land, with, in some cases, hold-down stakes or the like embedding partly in to the ground. However, this configuration makes the protective devices, enclosures, covers, and greenhouses susceptible to being displaced by strong winds.

This problem is typically overcome in larger protective devices, enclosures and greenhouses by providing a foundation in the ground. However, these types of protective devices, enclosures and greenhouses are relatively complicated structures which can be costly to build.

### SUMMARY OF THE INVENTION

What is desired is to provide an improved greenhouse and method of making the same for growing plants in a climate controlled environment protected from adverse weather conditions, insects, and animals, wherein disadvantages of prior devices are avoided or minimized.

In particular, greenhouses according to the present invention are relatively simple, yet sturdy structures, which are quick to build, and less expensive. Some embodiments of the present invention implement a stacked configuration which increases the amount of plants that can be grown at a given time in a given area of land.

Therefore, in accordance with one aspect of the present invention, there is provided a greenhouse comprising:
at least one elongate self-supporting tube having a wall defining an interior space, said at least one tube being formed from a light transmissive material to permit plant growth within said interior space; and
a growing medium disposed in said interior space.

Conveniently, the at least one tube may be a spiral wound tube formed from one or more than one web of material comprising most preferably polycarbonate, and having a wall comprising helical or non-helical corrugations. An interior surface of the wall may be rifled to assist with the distribution of air and moisture inside the greenhouse structure.

Conveniently still, the greenhouse may further comprise a base support system supporting the at least one tube. Alternately, the greenhouse may comprise a plurality of tubes at least some of the plurality of tubes being supported by the base support system, and the remaining tubes being stacked on top of other tubes including those tubes which are supported by the base support system.

Most preferably, the greenhouse will comprise an assembly comprising nine tubes and a topmost tube arranged in the shape of a pyramid, wherein the topmost tube is stacked on top of two tubes arranged in side-by-side relation, which are in turn stacked on top of three tubes arranged in side-by-side relation, which are in turn stacked on top of four tubes arranged in side-by side-relation.

In accordance with another aspect of the present invention, there is provided a greenhouse comprising:
at least one elongate self-supporting tube having a wall defining an interior space, said at least one tube being formed from a light transmissive material;
said interior space being sized to accommodate 1) a plant having a root system and a shoot system, and 2) a sufficient amount of growing medium to support growth of said plant.

Conveniently, the greenhouse may further comprise end caps attached at both ends of said at least one tube to permit climate control in said interior space.

In accordance with another aspect of the present invention, there is provided a method of making a greenhouse comprising the steps of:
forming at least one elongate self-supporting tube having a wall defining an interior space, said at least one tube being formed from at least one web of light transmissive material to permit plant growth within said interior space; and
disposing a growing medium in said interior space.

Conveniently, the method may further comprise the steps of forming a base support system and supporting said at least one tube in said base support system.

Conveniently, the forming the at least one tube step comprises deforming and spiral winding of the at least one web of material comprising polycarbonate. However, the forming the at least one tube step preferably further comprises, deforming sides of the at least one web of material into hook-shaped features which interlock with one another as the web of material is being deformed and spirally wound. It is contemplated that the at least one tube will be formed from a plurality of webs of material and that the method will further comprise the step of joining the plurality of webs of material together, for example by overlapping an end of one of the plurality of webs of material with an end of another one of the plurality of webs of material and rivetting the overlapping ends together.

Preferably, the method further comprises providing helical or non-helical corrugations into the wall of the at least one tube and/or rifling the inside surface of the wall of the at least one tube.

Conveniently still, the method further comprises the steps of forming a plurality of tubes, and supporting at least some of the plurality of tubes in the base support system, and stacking the remaining tubes on top of other tubes including those tubes which are supported by the base support system.

Most preferably, the method will comprise the step of forming an assembly by arranging nine tubes and a topmost tube in the shape of a pyramid, wherein the topmost tube is stacked on top of two tubes arranged in side-by-side relation, which are in turn stacked on top of three tubes in side-by-side relation, which are in turn stacked on top of four tubes arranged in side-by-side relation.

In accordance with yet another aspect of the present invention there is provided a use of an elongate, self-supporting tube formed from a light transmissive material in the construction of a greenhouse.

### BRIEF DESCRIPTION OF THE DRAWINGS

Reference will now be made to the preferred embodiments of the present invention with reference, by way of example only, to the following drawings in which:

FIG. 1 is a perspective view of an embodiment of a greenhouse according to the present invention, the greenhouse being formed with a light transmissive tube having helical corrugations;

FIG. 2 is a side view of the greenhouse of FIG. 1;

FIG. 3 is a side view of a greenhouse according to another embodiment of the present invention, in which the light transmissive tube is formed from a plurality of sections joined together with couplers;

FIG. 4 is a side view of a greenhouse according to another embodiment of the present invention, in which the light transmissive tube has non-helical corrugations;

FIG. 5 is a cross-sectional view of a greenhouse according to another embodiment of the present invention having a base support system formed in the ground comprising a channel excavated from the ground;

FIG. 6 is a cross-sectional view of a greenhouse according to another embodiment of the present invention having a base support system formed in the ground comprising a channel in a concrete form foundation;

FIG. 7 is a cross-sectional view of a greenhouse according to another embodiment of the present invention having a base support system formed in the ground comprising a channel formed with a precast concrete foundation infilled with stone;

FIG. 8 is a cross-sectional view of a greenhouse according to another embodiment of the present invention having a base support system formed in the ground comprising a channel formed with a concrete foundation walls infilled with compacted sand;

FIG. 9 is a perspective view of an apparatus for forming tubes or sections of tubes according to an embodiment of the present invention;

FIG. 9a is a detail of FIG. 9 showing interlocking features;

FIG. 10 is a front view of a greenhouse according to another embodiment of the present invention formed with a single tube supported by a base support system;

FIG. 11 is a front view of a greenhouse according to another embodiment of the present invention formed with a pair of tubes arranged in side-by-side relation, and supported by a base support system;

FIG. 12 is a front view of a greenhouse according to another embodiment of the present invention formed with three tubes arranged such that a topmost tube is stacked on top of a pair of tubes arranged in side-by-side relation, which pair of tubes is supported by a base support system, and having a conduit;

FIG. 13 is a perspective view of the greenhouse in FIG. 12 further including a drainage pipe in the conduit, the drainage pipe being connected to drainage ports in the topmost tube;

FIG. 14 is a perspective view of an assembly of nine tubes and a topmost tube arranged in the shape of a pyramid, such that the topmost tube is stacked on top of a pair of adjacent tubes arranged in side-by-side relation, which are in turn stacked on top of three tubes arranged in side-by-side relation, which are in turn stacked on top of four tubes arranged in side-by-side relation, which four tubes are supported by a base support system;

FIG. 15 is a perspective view of fifteen assemblies arranged in side-by-side relation;

FIG. 16 is a perspective view of a facility comprising a building, fifteen assemblies attached to one side of the building, and another fifteen assemblies attached to the opposite side of the building;

FIG. 17 is a top view of the facility according to another embodiment of the present invention;

FIG. 18 is a perspective view of the inside of a facility with the roof removed according to an embodiment of the present invention showing a moveable platform for accessing the tubes;

FIG. 19 is a perspective view of the inside of a facility with the roof removed according to an embodiment of the present invention showing a moveable fan in position at one tube;

FIG. 20 is a perspective view of the inside of a facility with the roof removed according to an embodiment of the present invention showing a moveable fan in position at one tube and connected to a second tube with a hose;

FIG. 21 is a cross-sectional view of a part of a facility according to an embodiment of the present invention showing a moveable fan in position at one tube and connected to a second tube with a hose, and a second hose connected between the one tube and the second tube at the other ends of the tubes;

FIG. 22 is a perspective view of a facility set up on a plot of land according to an embodiment of the present invention;

FIGS. 23 to 25 are perspective views showing a facility being built; and

FIG. 26 is a top view of five facilities set up on a plot of land according to an embodiment of the present invention.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers. For the purposes of clarity, not every component is labelled in every figure, nor is every component of each embodiment of the invention shown where illustration is not necessary to allow those of ordinary skill in the art to understand the invention. Orientative words such as “top”, “topmost”, “bottommost”, “front”, and “side” as used herein are used for clarity with reference to the orientation of elements in the figures and are not intended to be limiting.

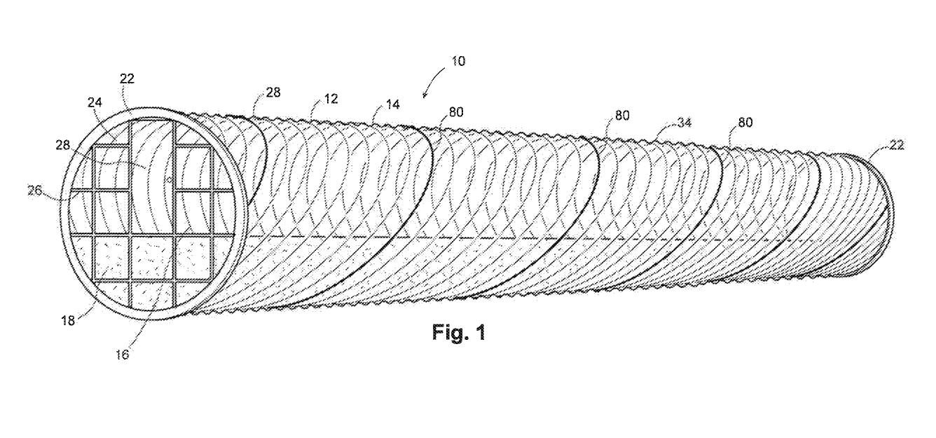

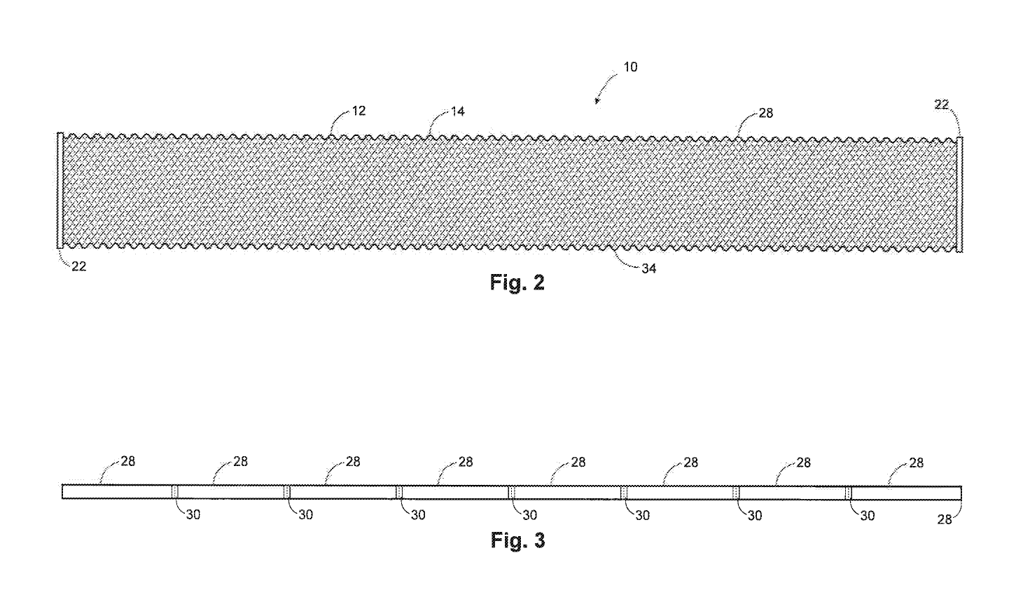

A greenhouse according to an embodiment of the present invention is generally indicated with reference numeral 10 in the figures. FIGS. 1 and 2 show a greenhouse 10 having an elongate, self-supporting tube 12 with a wall 14 defining an interior space 16. A growing medium 18, such as soil or a growing substrate, is disposed in the interior space 16 for growing plants 20. The tube 12 is formed from a light transmissive material, such as polycarbonate, to permit the plants 20 to grow in the interior space 16. An end cap 22 including light transmissive glazing 24 may be attached with, for example, fasteners to one, or both ends of the tube 12. The glazing is held in an anodised aluminum frame 26. Preferably, a means for ingress into and egress out of the interior space 16 of the tube 12, such as a door 28, is located in at least one of the end caps 22. The tube 12 and end caps 22 form an enclosure for protecting the plants 20 from adverse weather conditions, insects and animals. The enclosure also permits the creation of a climate controlled growing environment which is optimal for a particular plant or variety of plants by allowing for control of temperature, moisture, light, fertilizer, nutrients, and/or air composition, among numerous other parameters.

The preferred material for forming the wall 14 of the tube 12 is polycarbonate because it is strong, easy to work with and sufficiently light transmissive for the purposes of the present invention. However, persons skilled in the art will appreciate that they may select from numerous other materials having properties suitable for the purposes, all of which are intended to be covered by the present invention.

The tube 12 is preferably a spiral wound tube having a diameter of ten feet which is preferably formed in eighty foot sections 28 as shown in FIG. 3. However, it is to be understood that the tubes 12 of the present invention may be formed with any diameter and any length. For example, tubes 12 may be formed with shorter or longer sections 28. Furthermore, as shown in FIG. 3, the a plurality of sections 28 may be coupled together with couplers 30 to form longer tubes 12, for example, as long as six-hundred-forty feet (i.e. eight eighty foot sections coupled together) or longer. Couplers 30 are preferably a corrugated band of web of material which is wrapped about the ends of two abutting sections 30 of tube 12, which is secured with fasteners, such as screws or rivets.

As explained in more detail below, each section 28 of the tube 12 is preferably formed from one web of material 32. However, it is contemplated that the sections 28 of the tube 12 may be formed from a plurality of webs of material 32 joined together by fasteners; for example a seam of screws or rivets. Rivets have been found to yield good results because they allow for expansion and contraction of the overlapping ends of the webs of material 32.

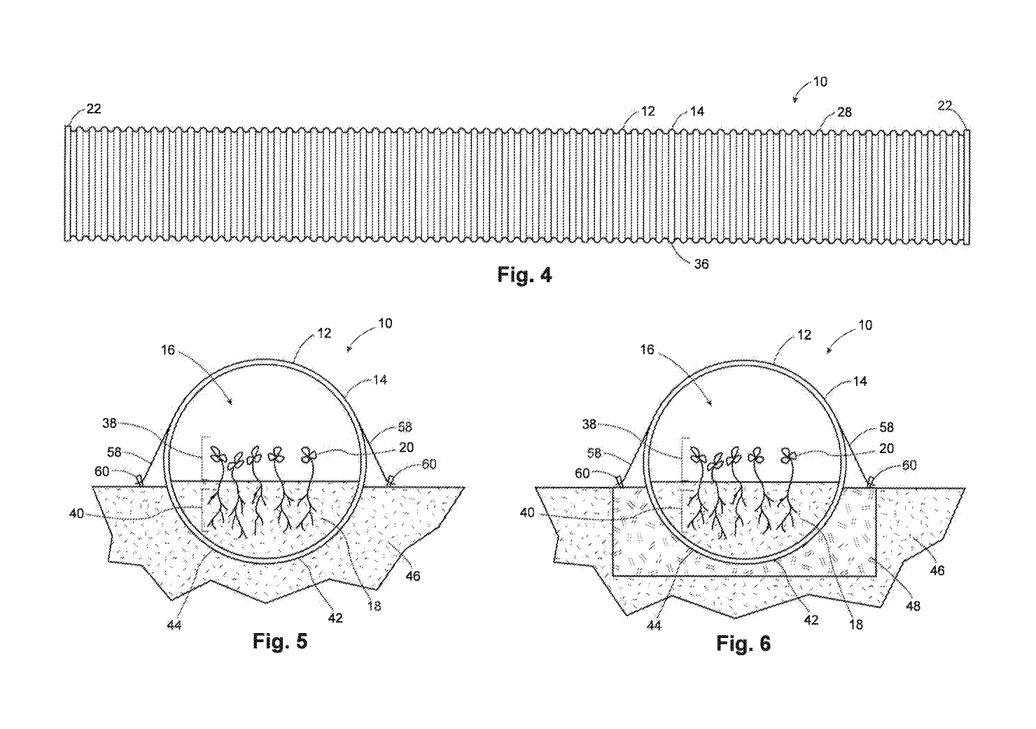

The tube 12 is preferably made self-supporting by, for example, forming the tube as a cylinder, providing the wall 14 with a sufficient thickness, forming the wall 14 using a sufficiently strong material, providing helical corrugations 34 in the wall 14 (FIG. 2), and/or providing non-helical corrugations 36 in the wall 14 (FIG. 4). For example, a tube 12 having a diameter of ten feet may be made self-supporting by providing a polycarbonate wall 14 of the tube 12 with a 0.187 inch (5 mm) wall thickness in conjunction with helical corrugations having a pitch and depth of 4.921 inches (125 mm) and 0.984 inches (25 mm) respectively.

Preferably, the tube 12 is formed with a diameter which is sized to permit a person and/or a piece of agricultural equipment to stand in the interior space 16 on top of the growing medium 18. Disposing growing medium 18 into the interior space 16 of the tube to a maximum depth which is 40% of the diameter of the tube yields good results. In a ten foot diameter tube 12, this represents a maximum depth of the growing medium of four feet along the midline of the tube 12. Thus a ten foot diameter tube 12 will provide a maximum height in the interior space 16 of about six feet if the growing medium 18 is disposed in the interior space 16 to a maximum height of four feet. A height of six feet has been found to be adequate for most persons.

However, it is also contemplated that the interior space 16 of the tube 12 will be sized to accommodate 1) a plant having a root system 38 and a shoot system 40, and 2) a sufficient amount of growing medium to support growth of said plant. Ideally the interior space will be sized to permit plants to be grown on a commercial scale. The curved base portion 42 of the tube permits growing of plants which would otherwise require a deeper growing medium. It is believed that this is due to the fact that the curved base portion 42 directs the root system along the curvature enabling it to grow longer than if the base portion 42 was flat.

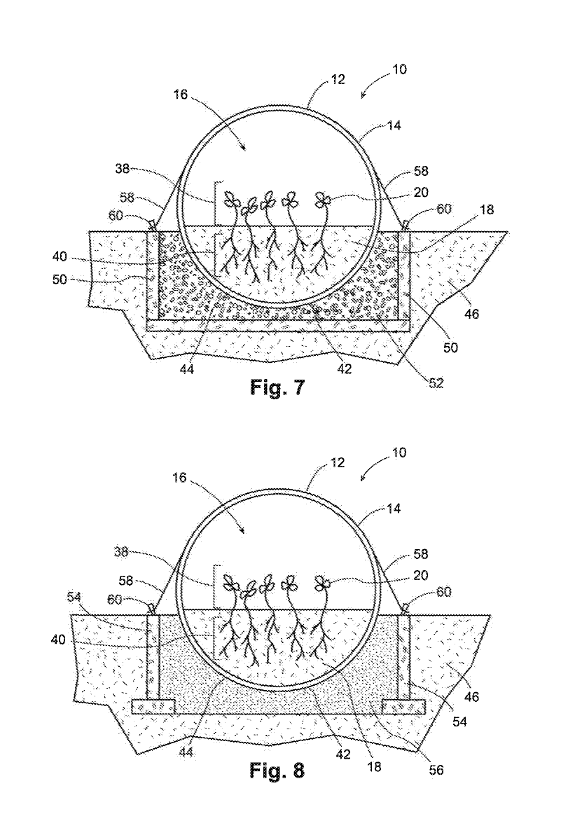

An exterior surface of a base portion 42 of the tube 12 is supported by a base support system, in FIG. 5, the base support system is a channel 44 which is sized and shaped to match the exterior surface of the base portion 42 of the tube 12. The channel 44 is preferably an excavation from the ground 46. However, the channel 44 may be a concrete form foundation 46 as shown in FIG. 6 or a precast concrete foundation 50 infilled with sand or stone as shown in FIG. 7. FIG. 8 shows a channel formed from foundation walls infilled with compact sand 56. In the preferred embodiment of the invention a securing means comprising a set of tie-downs or straps 58 are positioned at intervals along the length of the tube 12 and connected to anchor points 60 in the ground 46 or foundation 50, 54 are used to secure the tube 12 in the channel 44. Preferably the straps 58 will be formed of heavy duty webbing (polyester or nylon), steel cables, or the like.

Each section 28 of the tube 12 is preferably formed with a modified steel culvert making machine of the type disclosed in U.S. Pat. No. 3,247,692. The modifications to the machine include the addition of heating elements 62, 62′ at specific locations to permit substituting the steel sheet material, with polycarbonate web of material 32. The heating elements 62, 62′ are configured to heat the polycarbonate web of material 32 to a temperature at which it is sufficiently pliable that the subsequent deforming steps are able to proceed without stressing or fracturing the web of material 32.

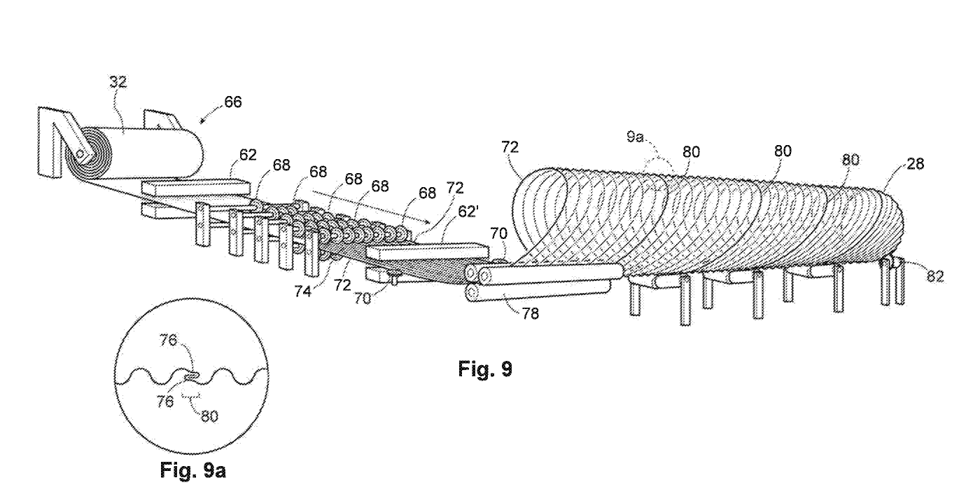

Accordingly, FIG. 9 shows an apparatus used in the forming of the sections 28 according to the present invention. The apparatus 64 carries at an upstream end a spool 66 of web of material 32 which is fed through a first heating element 62 to a series of rollers. In this example, the spool 66 carries a 100 inch wide, 304 foot long, 0.187 inch thick web of Lexan® XL102UV polycarbonate material available from Sabic Innovative Plastics, Mount Vernon, Ind., U.S.A.

The heating elements 62, 62′ heat the web of material 32 to a temperature of about 180° F., which has been found to make the polycarbonate web material 32 sufficiently pliable so that the subsequent deforming steps required to form the corrugations, interlocking features, and spiral winding proceed without stressing or fracturing the web of material 32. The series of rollers 68 sequentially deform the web of material 32 to provide corrugations. The rollers 68 may be adjusted to provide corrugations with pitches and depths according to the manufacturer's specifications to impart the structural integrity required for the tube 12. Forming the corrugations with a series of rollers 68 which work on a part of the web of material 32 at a time, rather than all at once with a single roller, has been found to avoid stress fractures. The corrugated web of material next passes a second heating element 62′ prior to being acted on by a pair of edge formers 70. The edge formers 70 deform the sides 72 of the corrugated web of material 74 into hook-shaped interlocking features 76 as best seen in FIG. 9a. Next the corrugated web of material 74 enters the winder and binder station of the apparatus 64 which deforms and spiral winds the corrugated web of material 75 into a cylindrical shape. As the corrugated web of material 74 is spiral wound into the cylinder shape the hook-shaped interlocking features 76 interlock with one another to form an interlocked seam 80, and the cylinder shape grows in length. When cylinder shape reaches a predetermined length, for example eighty feet, it is cut with a cutter 82, and the resulting section 28 moves along a conveyor to another location while the next section 28 is being formed, and so on until the spool 66 runs out of the web of material 32, at which point the spool 66 is replaced and the process begins again.

Accordingly, a web of material 32 carried on the spool 66 at one end of the apparatus 64 feeds through the apparatus 64 and exits the other end as sections 28 of a tube 12 transported on a conveyor to another location where the section 28 is either stored, or used to make a greenhouse 10 according to the present invention.

However, it is also contemplated, that when one spool 66 runs out of the web of material 32, it will be replaced with a new spool 64 carrying more web of material 32, and the free end of the web of material 32 it contains will be joined with fasteners to the end of the web of material 32 feeding into the apparatus 64. The joining of the ends of the webs of material 30 would preferably be accomplished by overlapping the two ends and rivetting them together with a seam of rivets. Rivets 34 have been found to yield good results because they allow for expansion and contraction of the overlapping ends of the webs of material 32. Thus a tube 12 of any length can be produced by joining a plurality of webs of material 32 from a plurality of spools 64. For example, a tube 12 having a diameter of ten feet and a length of six-hundred-forty feet may require eight spools 64.

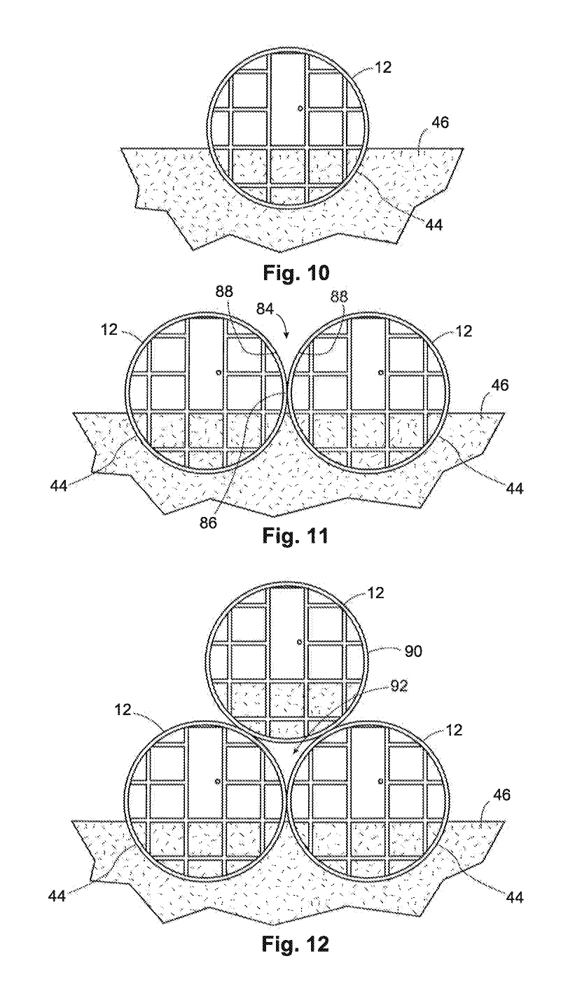

Referring now to FIG. 10 there is shown a greenhouse 10 having a single tube 12, supported by a base support system 44, according to an embodiment of the present invention. However, as shown in FIGS. 11 to 19, other embodiments of the invention are contemplated in which the greenhouse 10 includes a plurality of tubes 12, at least some of which are supported by the base support system 44.

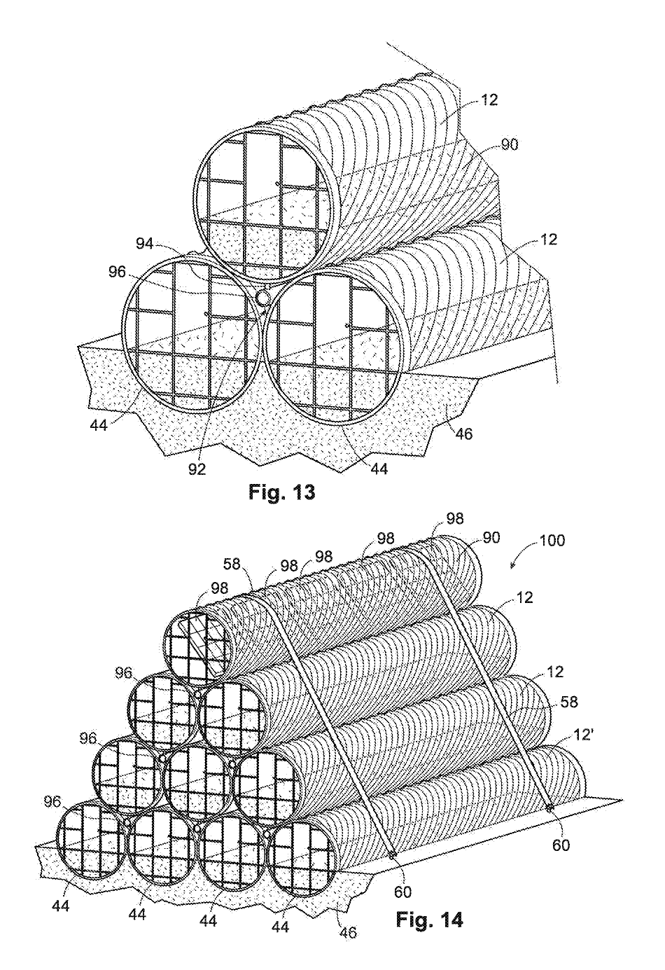

For example, FIG. 11 shows a pair of tubes 12 arranged in side-by-side relation. The pair of adjacent tubes 12 define a wedge-shaped channel 84 extending above a region 86 where the tubes are nearest to one another, and which is bounded by the exterior surface portions 88 of the tubes. In FIG. 12 a topmost tube 90 is stacked on top of the pair of tubes 12 of FIG. 11 supported by the wedge-shaped channel 84. The topmost tube 90 merely refers to the tube 12 which is the topmost tube in a stack of tubes 12 and may contain growing medium as in the case of the other tubes 12. A conduit 92 is formed when a tube 12 or topmost tube 90 is supported in said wedge-shaped channel, the conduit 92 being defined by the pair of adjacent tubes 12 and the tube 12 or topmost tube 90 stacked thereon. The conduit 92 can be used to house insulation, electrical wiring, a pipe for transporting liquid or gas, a drainage pipe, or combinations thereof. As shown in FIG. 13 drainage ports 94 are preferably provided in the tubes 12 and connected to drainage pipes 96 housed in the conduits 92.

Because of its location, the topmost tube 90 is ideally suited for housing one or more solar panels 98 which can be used to generate electric power for operating the greenhouse 10, for storage, or for distribution to the power grid for sale to a power authority. Thus the interior space 16 of the topmost tube 90 may contain growing medium 18, at least one solar panel 98 or a combination of the two.

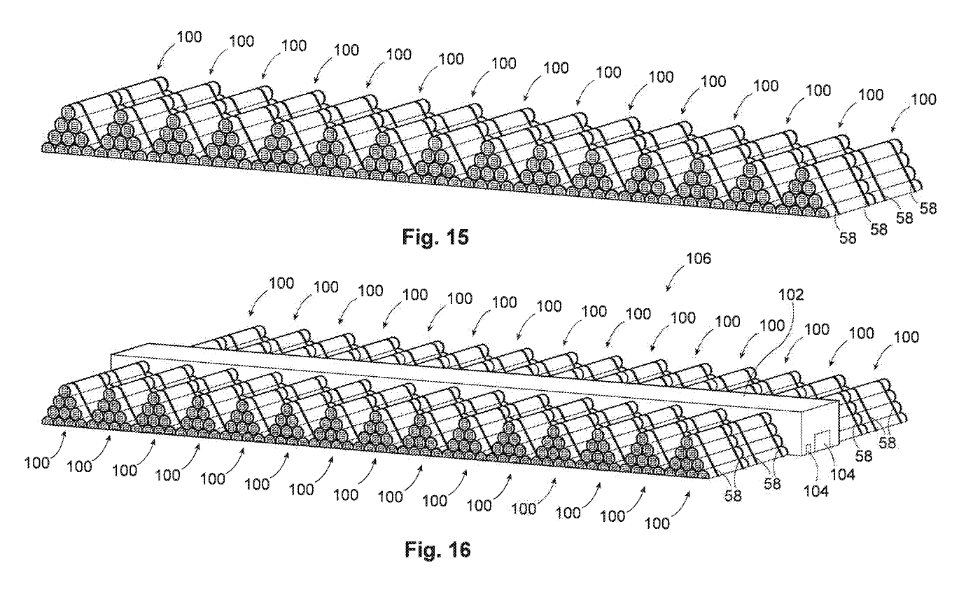

FIG. 14 shows a preferred assembly 100 of nine tubes 12 and a topmost tube 90 arranged in the shape of a pyramid, such that the topmost tube 90 is stacked on top of a pair of adjacent tubes 12 arranged in side-by-side relation, which are in turn stacked on top of three tubes 12 arranged in side-by-side relation, which are in turn stacked on top of four tubes 12 arranged in side by side relation. The bottommost tubes in the assembly 100 are supported by the excavated channel 44 base support system as previously discussed. Preferably the plurality of tubes 12 of the greenhouse will be suitably secured with a securing means comprising a set of tie-downs or straps 58 positioned at intervals along their lengths and connected to anchor points 60 in the ground 48, concrete foundations 48, or foundation walls 50, 54. It is further contemplated that a plurality of assemblies 100, for example fifteen assemblies, may be arranged in side-by-side relation, as shown in FIG. 15.

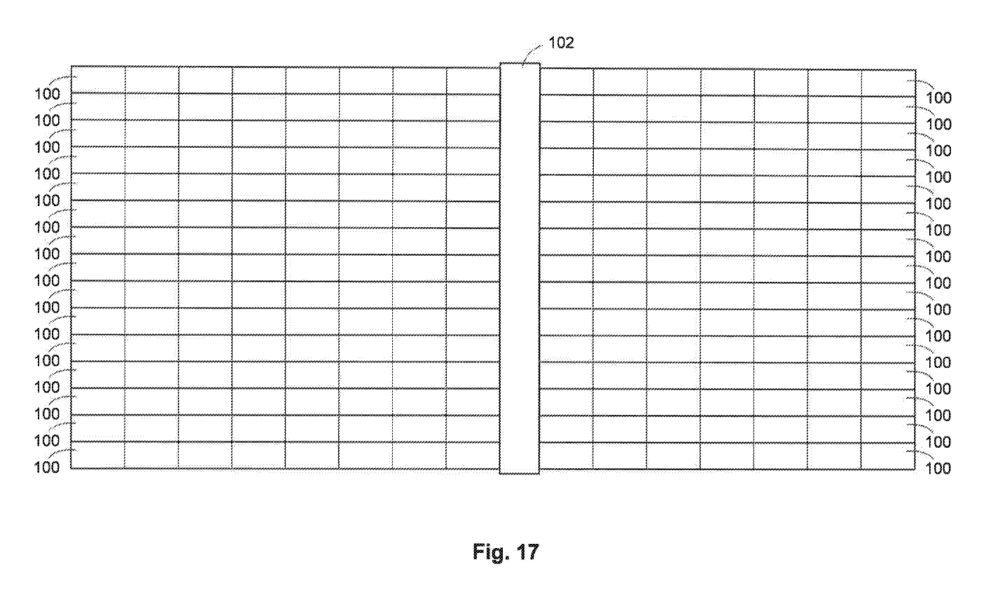

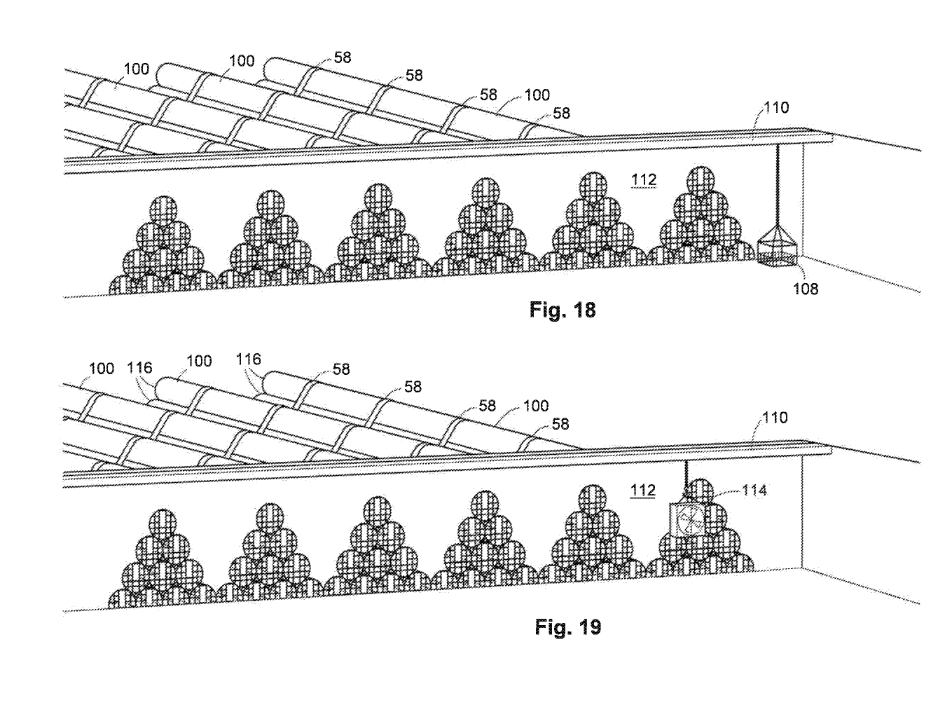

FIG. 16 shows an embodiment of the present invention in which a plurality of assemblies 100 are attached to one side of a building 102. Preferably, an entrance 104 will be provided in the building 102 in communication with at least some of the tubes 12 and the topmost tubes 90 in the assemblies through the interior of the building. The building 102 and the attached assemblies 100 define a facility 106. The facility 106 may include an additional plurality of assemblies 100 attached, for example, to the opposite side of the building 102 as best seen in FIG. 17. Most preferably each of the tubes 12 attached to the building 102 will be in communication with the interior of the building and accessible therethrough. For example, FIG. 18 shows a platform 108 suspended from a track 110 mounted to the ceiling of the building 102 which is configured to move both vertically and horizontally along the interior wall 112 of the building 102 to permit access to each of the tubes 12 and topmost tubes 90 in the assemblies 100. Thus the platform 108 can be used to transport people, equipment or the like from the ground to even the topmost tubes 90 of the assemblies 100. Of course other means for accessing the tubes 12 may be used such as stairs, ramps, escalators, elevators, and combinations thereof, as are well known in the art. Furthermore, it will be appreciated that the building 102 may be designed to house equipment, machinery, supplies, or the like related to growing, harvesting, storing and processing the plants grown in the assemblies 100.

The temperature and/or humidity inside individual tubes 12 and topmost tubes 90 of the assemblies 100 may be regulated from inside the building 102 in at least one of three ways. First, if the temperature of the air inside a particular tube is too low, and the ambient temperature of the air outside of the greenhouse is warmer than the required temperature, a fan 114 may be used as shown in FIG. 19 to draw the warmer ambient outside air into the tube 12 through a vent 116 in the tube's other end. The fan 114 is preferably suspended from a track 110 and can be moved vertically and horizontally inside the building 102 to permit being positioned at any of the tubes 12 in the assemblies 100. Similarly, if the temperature of the air inside a particular tube is too high, and the ambient temperature of the air outside of the greenhouse 10 is colder than the required temperature, the fan 114 may be used to draw the colder ambient outside air into the tube 12 through the vent 116.

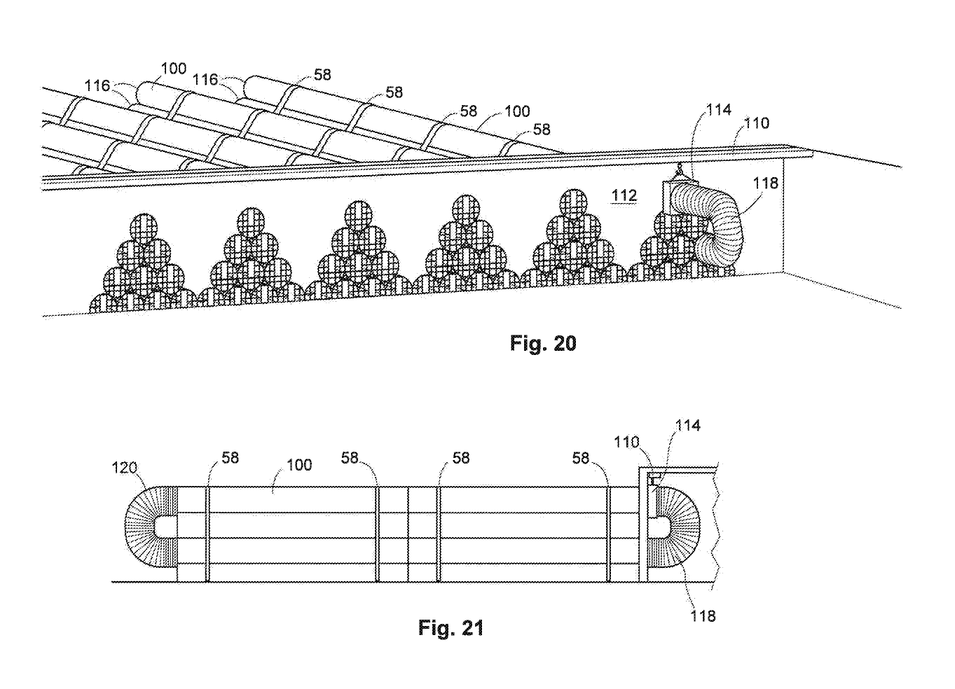

Second, it is contemplated, that in certain situations air from one tube may be circulated to another tube with a fan 114 and hose 118 configuration as shown in FIG. 20. As above, the fan 114 is suspended from the track 110, and air is moved from one tube to the second tube. In the example shown in FIG. 20, the air in the first tube is replaced with outside air through vents, and the air in the second tube is evacuated through vents to the outside to make room for the incoming air. However, in the embodiment shown in FIG. 21 the vents of the two tubes are connected with a second hose 120 to permit true cycling of air from one tube to another. The embodiments in FIGS. 20 and 21 permit using warmer or colder air trapped in tubes in the assemblies to raise or lower the temperature of other tubes in the assemblies.

Third, a heater or air conditioner may be associated with the fan 114 to heat or cool individual tubes. A humidifier may be associated with the fan 114 to increase relative humidity inside tubes, and the air conditioner may be used to reduce relative humidity inside the tubes.

Disposing the solar panels 98 in the topmost tubes 90 of the greenhouse 10 exposes them to the greatest amount of sunlight, while protecting them from damage due to adverse weather conditions. However, an added benefit is that it is possible to maintain the solar panels 98 at a temperature allowing optimal performance by regulating the temperatures inside the tubes as discussed above. In general, solar panels begin to lose efficiency as temperature increases above about 77° F. (25° C.).

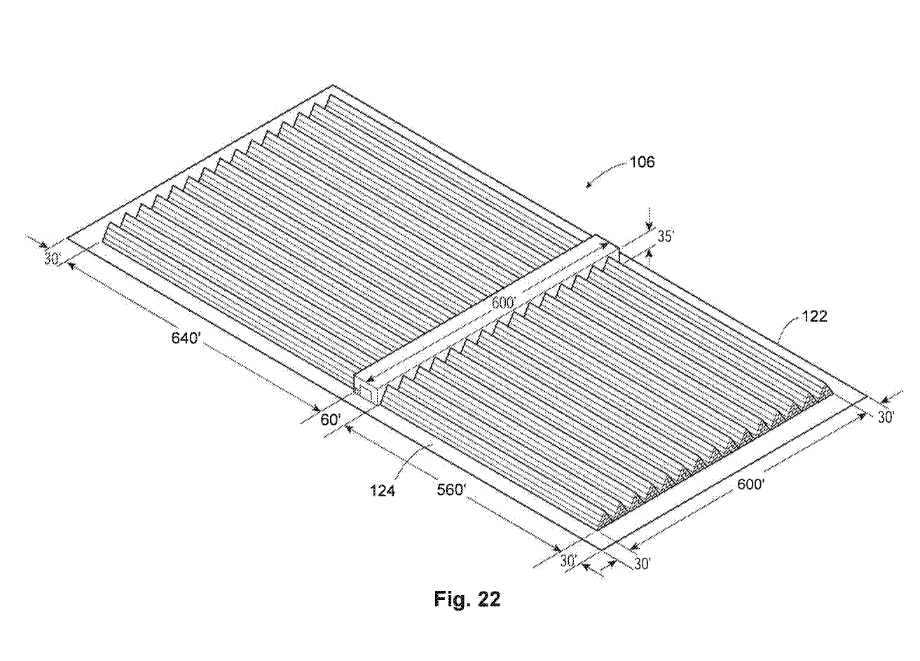

By way of example FIG. 22 shows a facility 106 on a twenty acre plot of land 122 measuring six-hundred-sixty feet wide by 1320 feet long. The building 102 is erected sixty feet wide by six-hundred feet long by thirty-five feet high off center of the length of the plot of land 122, at right angles to an access road 124. Fifteen assemblies 100 of tubes 12 formed from eight eighty foot sections 28 (giving a combined length of six-hundred-forty feet) are provided on one side of the building 102, and fifteen assemblies of tubes 12 formed from seven eighty foot sections (giving a combined length of five-hundred-sixty feet) are provided on the opposite side of the building 102.

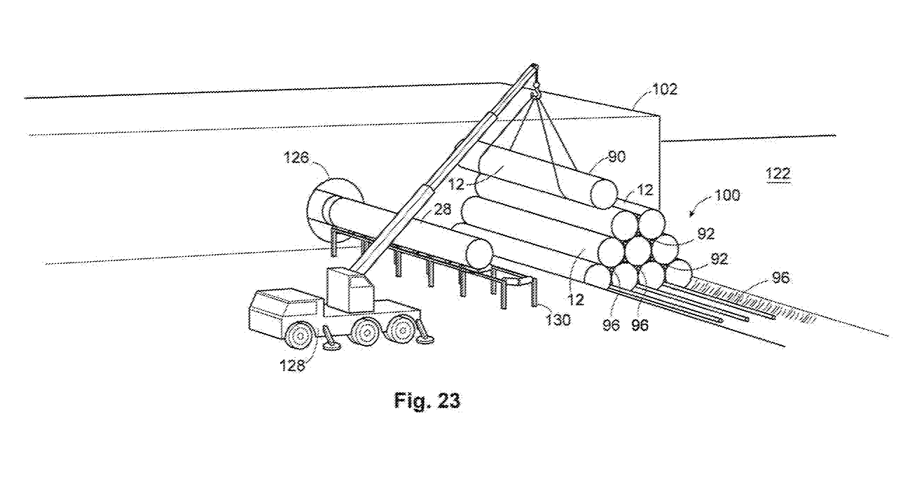

FIGS. 23 to 25 show a facility 106 being constructed according to an embodiment of the present invention. First a building 102 is constructed on a plot of land 122. In this example the plot of land 122 is twenty acres measuring six-hundred-sixty feet wide by one-thousand-three-hundred-twenty feet long. Preferably, the building 102 is sixty feet wide, by six-hundred feet long by thirty-five feet tall, and positioned forty feet off centre of the length of the plot of land 122. Inside the building 102 is housed the apparatus 64 (best seen in FIG. 9) for forming the sections 28 of tubes 12. Referring now to FIG. 23, it can be seen that an access opening 126 in the side of the building 102 permits the eighty foot sections 28 to be moved to outside of the building 102 as they are being made to a mobile crane 128 waiting outside via a conveyor 130. The mobile crane 128 then puts the sections 28 in place to the first assembly 100 beginning with the base support system and then stacking them up in the shape of a pyramid as previously described. Insulation, electrical wiring, pipes for transporting liquid or gas, and/or drainage pipes 96 are installed in the conduits 92 as the sections 28 are being put in place. Drainage ports 94 inside the sections 28 of the tubes 12 are also connected to the drainage pipes 96 in the conduits 92. Openings 132 for accessing the tubes 12 may be formed in the building 102 before the tubes 12 are attached or afterwards.

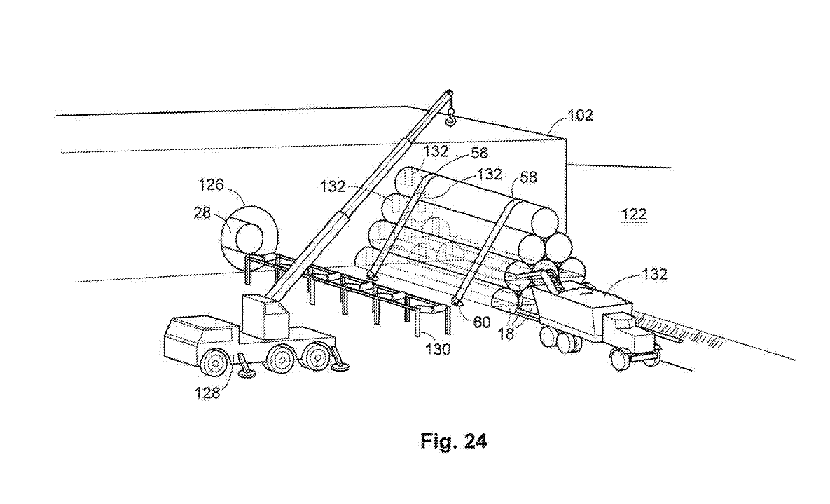

Referring now to FIG. 24, the sections 28 of the tubes 12 are secured with tie-down straps 58 and anchor points 60. Soil is disposed inside the sections 28 of tubes 12 with a slinger truck 134.

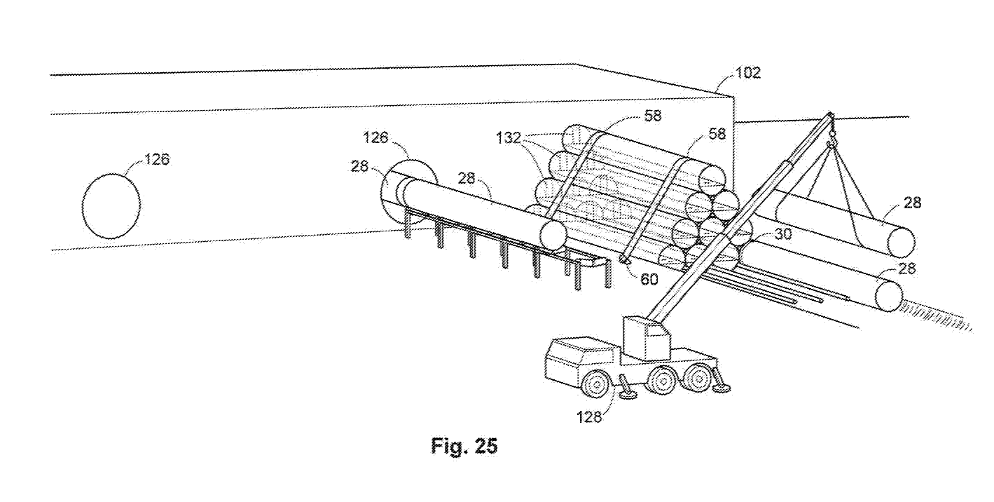

As shown in FIG. 25, the process is repeated as more sections 28 of tubes 12 are moved into place by the mobile crane 128 and joined to the sections 28 of tube 12 with couplers 30. Once an assembly 100 is built, the access opening 126 in the building 102 is closed and the process is repeated for the next assembly 100. In the preferred embodiment fifteen assemblies 100 are attached on one side of the building 102 and another fifteen assemblies are attached on the other side of the building 102. Preferably, the assemblies 100 on one side of the building 102 will be formed from eight eighty foot sections 28 having a combined length of six-hundred-forty feet. The assemblies 100 on the other side of the building will be formed from seven eighty foot sections 28 having a combined length of five-hundred-sixty feet. End caps 22 are attached to the ends of the tubes 12 in the assemblies. Preferably the end caps 22 will include vent openings 116 which may be opened and closed as desired.

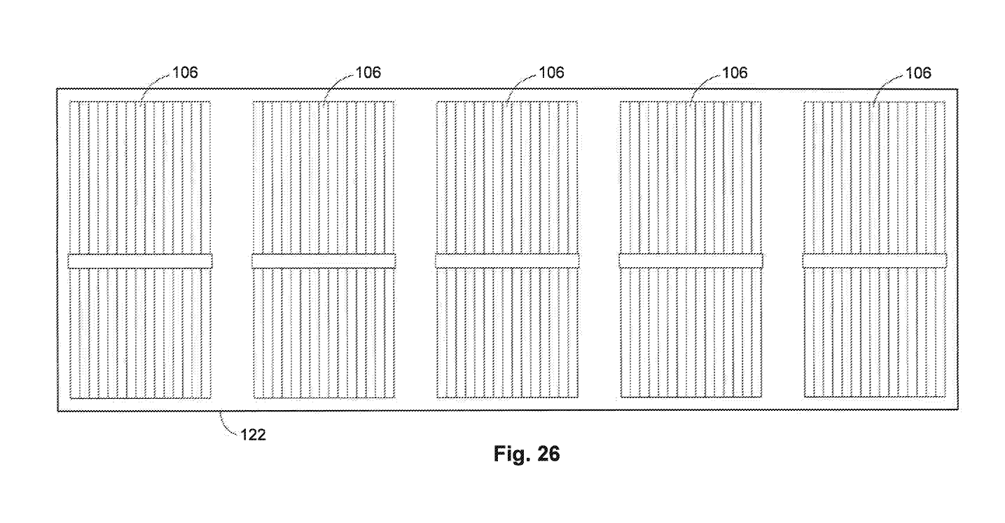

As will be appreciated, a plurality of facilities 106 may be arranged in proximity to one another on a plot of land 122. For example, FIG. 26 shows five such facilities 106 arranged on a plot of land 122. However, it will be understood that more or fewer facilities may be so arranged provided that there is sufficient room on the plot of land to accommodated them.

While reference has been made to various preferred embodiments of the invention other variations, implementations, modifications, alterations and embodiments are comprehended by the broad scope of the appended claims. Some of these have been discussed in detail in this specification and others will be apparent to those skilled in the art. Those of ordinary skill in the art having access to the teachings herein will recognize these additional variations, implementations, modifications, alterations and embodiments, all of which are within the scope of the present invention and intended to be covered by the appended claims, without limitation.

1. A greenhouse comprising:
at least one elongate self-supporting tube having a wall defining an interior space, said at least one tube being formed from a light transmissive material to permit plant growth within said interior space; and
a growing medium disposed in said interior space.

2. The greenhouse as claimed in claim 1, further comprising at least one end cap attached at one end of said at least one tube.

3. The greenhouse as claimed in claim 2, further comprising a means for ingress/egress located in said at least one end cap.

4. The greenhouse as claimed in claim 3, wherein said means for ingress/egress is a door.

5. The greenhouse as claimed in claim 4, wherein said at least one end cap comprises glazing.

6. The greenhouse as claimed in claim 2, comprising end caps attached at both ends of said at least one tube to permit climate control in said interior space.

7. The greenhouse as claimed in claim 1, wherein said at least one tube is a spiral wound tube formed from at least one web of material.

8. The greenhouse as claimed in claim 7, wherein said at least one web of material comprises polycarbonate.

9. The greenhouse as claimed in claim 8, wherein said wall of said at least one tube comprises helical corrugations or non-helical corrugations.

10. The greenhouse as claimed in claim 7, wherein said spiral wound tube is formed from a plurality of webs of material joined together with fasteners.

11. The greenhouse as claimed in claim 1, wherein said spiral wound tube comprises at least two sections joined together with a coupler.

12. The greenhouse as claimed in claim 1, wherein said wall has an interior surface which is rifled.

13. The greenhouse as claimed in claim 1, wherein said growing medium is a soil or a growing substrate.

14. The greenhouse as claimed in claim 13, wherein said at least one tube has a diameter and said growing medium has a maximum depth which is 40% of said diameter.

15. The greenhouse as claimed in claim 14, wherein said diameter is sized to permit a person and/or a piece of agricultural equipment to stand in said interior space on top of said growing medium.

16. The greenhouse as claimed in claim 15, wherein said diameter is at least about ten feet.

17. The greenhouse as claimed in claim 16, wherein said maximum depth of said growing medium is about four feet.

18. The greenhouse as claimed in claim 16, wherein said at least one tube has a length of at least about six-hundred feet.

19. The greenhouse as claimed in claim 1, further comprising a base support system supporting said at least one tube.

20. The greenhouse as claimed in claim 19, wherein said base support system is formed in a ground.

21. The greenhouse as claimed in claim 20, wherein said base support system comprises a channel sized and shaped to match an exterior surface of said at least one tube.

22. The greenhouse as claimed in claim 21, wherein said channel has a maximum depth of about 40% of a diameter of said at least one tube.

23. The greenhouse as claimed in claim 22, wherein said maximum depth of said channel is about four feet.

24. The greenhouse as claimed in claim 21, wherein said channel comprises an excavation from the ground.

25. The greenhouse as claimed in claim 21, wherein said channel comprises a concrete form foundation.

26. The greenhouse as claimed in claim 21, wherein said channel comprises a precast concrete foundation.

27. The greenhouse as claimed in claim 19, comprising a plurality of tubes, at least some of said plurality of tubes being supported by said base support system.

28. The greenhouse as claimed in claim 27, wherein a pair of tubes of said plurality of tubes are arranged in side-by-side relation, said pair of adjacent tubes defining a wedge-shaped channel extending above a region where the pair of adjacent tubes are nearest to one another, and being bounded by exterior surfaces of said pair of adjacent tubes.

29. The greenhouse as claimed in claim 28, further comprising another one of said plurality of tubes or a topmost tube supported by said wedge-shaped channel, wherein said topmost tube defines an interior space, and comprises a growing medium and/or at least one solar panel disposed in said interior space.

30. The greenhouse as claimed in claim 29, further comprising means for securing (i) said plurality of tubes and said another one of said plurality of tubes, or (ii) said plurality of tubes and said topmost tube.

31. The greenhouse as claimed in claim 30, wherein said securing means comprises a set of tie-downs positioned at intervals along a length of said greenhouse.

32. The greenhouse as claimed in claim 31, wherein (i) said pair of adjacent tubes and said another one of said plurality of tubes, or (ii) said pair of adjacent tubes and said topmost tube, define a conduit for housing insulation, electrical wiring, a pipe for transporting liquid, a pipe for transporting gas, a drainage pipe, or combinations thereof.

33. The greenhouse as claimed in claim 32, wherein said another one of said plurality of tubes and/or said top most tube comprises drainage ports connected to said drainage pipe.

34. The greenhouse as claimed in claim 33, comprising an assembly comprising nine tubes and said topmost tube arranged in the shape of a pyramid, wherein said topmost tube is stacked on top of two tubes arranged in side-by-side relation, which are in turn stacked on top of three tubes arranged in side-by-side relation, which are in turn stacked on top of four tubes arranged in side-by-side relation.

35. The greenhouse as claimed in claim 34, further comprising a plurality of said assemblies arranged in side-by-side relation.

36. The greenhouse as claimed in claim 35, wherein fifteen of said assemblies are arranged in side-by-side relation.

37. The greenhouse as claimed in claim 34, further comprising a building having one side attached to said plurality of assemblies, wherein said building has an entrance in communication with at least some of the tubes and said topmost tubes in said assemblies, said building and attached assemblies defining a facility.

38. The greenhouse as claimed in claim 37, further comprising an additional plurality of assemblies attached to another side of said building.

39. The greenhouse as claimed in claim 37, further comprising a means for regulating temperature and/or humidity in at least some of the tubes and said topmost tubes in said assemblies.

40. The greenhouse as claimed in claim 37, comprising a plurality of facilities arranged in proximity to one another.

41. The greenhouse as claimed in claim 40, comprising five facilities arranged in proximity to one another.

42. A method of making a greenhouse comprising the steps of:
forming at least one elongate self-supporting tube having a wall defining an interior space, said at least one tube being formed from at least one web of light transmissive material to permit plant growth within said interior space;
disposing a growing medium in said interior space.

43. The method as claimed in claim 42, further comprising the step of:
attaching an end cap to at least one end of said at least one tube.

44. The method as claimed in claim 43, further comprising the step of:
providing said end cap with a means for ingress/egress.

45. The method as claimed in claim 44, wherein said means for ingress/egress is a door.

46. The method as claimed in claim 45, wherein said end cap comprises glazing.

47. The greenhouse as claimed in claim 42, wherein said forming said at least one tube step comprises deforming and spiral winding of said at least one web of material.

48. The method as claimed in claim 47, wherein said forming said at least one tube step further comprises, deforming sides of said at least one web of material into hook-shaped features which interlock with one another as the web of material is being deformed and spiral wound.

49. The method as claimed in claim 42, further comprising providing helical or non-helical corrugations into said wall of said at least one tube.

50. The greenhouse as claimed in claim 42, further comprising rifling the inside surface of said wall of said at least one tube.

51. The method as claimed in claim 42, wherein said at least one web of material comprises polycarbonate.

52. The method as claimed in claim 42, wherein said growing medium is a soil or a growing substrate.

53. The method as claimed in claim 52, wherein said growing medium is disposed in said interior space to a maximum depth which is about 40% of the diameter of the tube.

54. The method as claimed in claim 53, wherein said at least one tube is formed with a diameter sized to permit a person and/or a piece of agricultural equipment to stand in said interior space on top of said growing medium.

55. The method as claimed in claim 54, wherein said diameter is ten feet.

56. The method as claimed in claim 54, wherein said at least one tube is formed from a plurality of webs of material and said method further comprises the step of:
joining said plurality of webs of material together.

57. The method as claimed in claim 56, wherein said step of joining said plurality of webs of material together comprises overlapping an end of one of said plurality of webs of material with an end of another one of said plurality of webs of material and rivetting the overlapping ends together.

58. The method as claimed in claim 54, wherein said at least one tube is formed from at least two sections and said method further comprises the step of:
joining said sections together with a coupler.

59. The method as claimed in claim 56 or 58, wherein said at least one tube has a length of about six-hundred feet.

60. The method as claimed in claim 42 further comprising the steps of:
forming a base support system; and
supporting said at least one tube in said base support system.

61. The method as claimed in claim 60, wherein said base support system is formed in a ground.

62. The method as claimed in claim 61, wherein said step of forming said base support system in the ground comprises the step of forming in said ground a channel sized and shaped to match an exterior surface of said at least one tube.

63. The method as claimed in claim 62, wherein said channel has a maximum depth of about 40% of the diameter of said at least one tube.

64. The method as claimed in claim 63, wherein said maximum depth of said channel is about four feet.

65. The method as claimed in claim 62, wherein said step of forming said base support system comprises excavating said channel from the ground.

66. The method as claimed in claim 62, wherein said step of forming said base support system comprises forming a concrete form of the channel in the ground.

67. The method as claimed in claim 62, wherein said step of forming said base support system comprises building a foundation and forming the channel with infilled stone or sand.

68. The method as claimed in claim 42, further comprising the steps of:
forming a plurality of tubes; and
supporting at least some of said plurality of tubes in said base support system.

69. The method as claimed in claim 68, comprising the step of:
arranging a pair of tubes of said plurality of tubes in side-by-side relation, said pair of adjacent tubes defining a wedge-shaped channel extending above a region where the pair of adjacent tubes are nearest to one another, and being bounded by exterior surfaces of said pair of adjacent tubes.

70. The method as claimed in claim 69, further comprising the step of:
supporting another one of said plurality of tubes or a topmost tube in said wedge-shaped channel, wherein said topmost tube defines an interior space.

71. The method as claimed in claim 70, further comprising the step of:
disposing a growing medium and/or at least one solar panel in said interior space of said topmost tube.

72. The method as claimed in claim 70, further comprising the step of:
securing (i) said plurality of tubes, or (ii) said plurality of tubes and said topmost tube.

73. The method as claimed in claim 72, wherein said securing step comprises positioning a set of tie-downs at intervals along a length of said greenhouse.

74. The method as claimed in claim 70, wherein (i) said pair of adjacent tubes and said another one of said plurality of tubes, or (ii) said pair of adjacent tubes and said topmost tube, define a conduit, said method further comprising the step of:
housing in said conduit insulation, electrical wiring, a pipe for transporting liquid, a pipe for transporting gas, a drainage pipe, or combinations thereof.

75. The method as claimed in claim 70, further comprising the steps of providing drainage ports in said another one of said plurality of tubes and/or said topmost tube; and
connecting said drainage ports to said drainage pipe.

76. The method as claimed in claim 75, further comprising the step of:
forming an assembly by arranging nine tubes and said topmost tube in the shape of a pyramid, wherein said topmost tube is stacked on top of two tubes arranged in side-by-side relation, which are in turn stacked on top of three tubes in side-by-side relation, which are in turn stacked on top of four tubes arranged in side-by-side relation.

77. The method as claimed in claim 76, further comprising the step of:
arranging a plurality of said assemblies in side-by-side relation.

78. The method as claimed in claim 77, wherein said plurality of said assemblies comprises fifteen assemblies arranged in side-by-side-relation.

79. The method as claimed in claim 77, further comprising the step of:
attaching said plurality of assemblies to a building having an entrance in communication with at least some of the tubes and said topmost tubes in said assemblies, said building and attached assemblies defining a facility.

80. The method as claimed in claim 78, further comprising the step of:
attaching an additional plurality of said assemblies to another side of said building.

81. The method as claimed in claim 80, wherein said additional plurality of said assemblies comprises fifteen assemblies arranged in side-by-side relation.

82. The method as claimed in claim 79, further comprising the step of:
regulating a temperature and/or humidity in at least some of the tubes and said topmost tubes in said assemblies.

83. The method as claimed in claim 79, further comprising the step of:
arranging a plurality of facilities in proximity to one another.

84. The method as claimed in claim 83, wherein said plurality of facilities comprises five facilities arranged in proximity to one another.

85. A greenhouse comprising:
at least one elongate self-supporting tube having a wall defining an interior space, said at least one tube being formed from a light transmissive material;
said interior space being sized to accommodate 1) a plant having a root system and a shoot system, and 2) a sufficient amount of growing medium to support growth of said plant.

86. A use of an elongate, self-supporting tube formed from a light transmissive material in the construction of a greenhouse.

87. The greenhouse as claimed in claim 38, further comprising a means for regulating temperature and/or humidity in at least some of the tubes and said topmost tubes in said assemblies.

88. The greenhouse as claimed in claim 38, comprising a plurality of facilities arranged in proximity to one another.

89. The method as claimed in claim 58, wherein said at least one tube has a length of about six-hundred feet.

90. The method as claimed in claim 80 further comprising the step of:
regulating a temperature and/or humidity in at least some of the tubes and said topmost tubes in said assemblies.

91. The method as claimed in claim 81 further comprising the step of:
regulating a temperature and/or humidity in at least some of the tubes and said topmost tubes in said assemblies.

92. The method as claimed in claim 80, further comprising the step of:
arranging a plurality of facilities in proximity to one another.

93. The method as claimed in claim 81, further comprising the step of:
arranging a plurality of facilities in proximity to one another
